(19) United States
(12) Patent Application Publication
(10) Pub. No.: US 2025/0164653 A1
(43) Pub. Date: May 22, 2025

(54) METHODS, SYSTEMS, AND STORAGE MEDIA FOR OBTAINING ENERGY SPECTRA

(71) Applicant: SHANGHAI UNITED IMAGING HEALTHCARE CO., LTD., Shanghai (CN)

(72) Inventor: Zhi SHI, Shanghai (CN)

(73) Assignee: SHANGHAI UNITED IMAGING HEALTHCARE CO., LTD., Shanghai (CN)

(21) Appl. No.: 19/023,201

(22) Filed: Jan. 15, 2025

Related U.S. Application Data
(63) Continuation of application No. PCT/CN2022/108311, filed on Jul. 27, 2022.

(51) Int. Cl. G01T 1/36; G01N 23/06; G01T 1/161

(52) U.S. Cl. CPC G01T 1/36; G01N 23/06; G01T 1/161; G01N 2223/3035; G01N 2223/305; G01N 2223/612; G01N 2223/633

(57) ABSTRACT

Provided are a method, a system, and a storage medium for obtaining an energy spectrum. The method comprises: obtaining a first depth dose curve corresponding to a first energy and a second depth dose curve corresponding to a second energy; obtaining, based on the first depth dose curve and the second depth dose curve, a first set of dose values and a second set of dose values along a depth direction, respectively; determining a relationship between the first depth dose curve and the second depth dose curve based on the first set of dose values and the second set of dose values; obtaining a first energy spectrum corresponding to the first depth dose curve; and determining a second energy spectrum corresponding to the second depth dose curve based on the first energy spectrum and the relationship between the first depth dose curve and the second depth dose curve.

### CROSS-REFERENCE TO RELATED APPLICATIONS

This application is a continuation of International Application No. PCT/CN2022/108311, filed on Jul. 27, 2022, the entire contents of which are incorporated herein by reference.

### TECHNICAL FIELD

The present disclosure relates to the technical field of radiotherapy, and in particular, to a method, a system, and a storage medium for obtaining an energy spectrum.

### BACKGROUND

Radiation therapy is one of the most important ways to treat malignant tumors. In many applications in the field of radiotherapy, such as in the prediction of a dose distribution in the body of a patient, the energy spectrum of a beam is the key to accurate calculations. For example, a Monte Carlo algorithm is utilized clinically to predict the dose distribution. The Monte Carlo algorithm is a stochastic simulation method that accurately obtains the dose distribution of particles in a phantom by stochastically simulating the interaction between particles in a radiation beam with atoms in the phantom. In the Monte Carlo algorithm, the energy spectrum is the basis for performing accurate dose calculations.

Therefore, it is desirable to provide a technical solution for obtaining the energy spectrum, which can improve the computational efficiency of the energy spectrum.

### SUMMARY

One or more embodiments of the present disclosure provide a method for obtaining an energy spectrum. The method comprises: obtaining a first depth dose curve corresponding to a first energy and a second depth dose curve corresponding to a second energy; obtaining, based on the first depth dose curve and the second depth dose curve, a first set of dose values and a second set of dose values along a depth direction, respectively; determining a relationship between the first depth dose curve and the second depth dose curve based on the first set of dose values and the second set of dose values; obtaining a first energy spectrum corresponding to the first depth dose curve; and determining a second energy spectrum corresponding to the second depth dose curve based on the first energy spectrum and the relationship between the first depth dose curve and the second depth dose curve.

One or more embodiments of the present disclosure provide a system for obtaining an energy spectrum. The system comprises a curve acquisition module, a dose value acquisition module, a relationship determination module, a first energy spectrum acquisition module, and a second energy spectrum determination module. The curve acquisition module is configured to obtain a first depth dose curve corresponding to a first energy and a second depth dose curve corresponding to a second energy. The dose value acquisition module is configured to obtain, based on the first depth dose curve and the second depth dose curve, a first set of dose values and a second set of dose values along a depth direction, respectively. The relationship determination module is configured to determine a relationship between the first depth dose curve and the second depth dose curve based on the first set of dose values and the second set of dose values. The first energy spectrum acquisition module is configured to obtain a first energy spectrum corresponding to the first depth dose curve. The second energy spectrum determination module is configured to determine a second energy spectrum corresponding to the second depth dose curve based on the first energy spectrum and the relationship between the first depth dose curve and the second depth dose curve.

One or more embodiments of the present disclosure provide a computer-readable storage medium storing computer instructions. When a computer reads the computer instructions from the storage medium, the computer executes the method for obtaining an energy spectrum disclosed in the present disclosure.

One or more embodiments of the present disclosure provide a device for obtaining an energy spectrum. The device comprises at least one processor and at least one storage device. The at least one storage device is configured to store computer instructions, and the at least one processor is configured to execute at least a portion of the computer instructions to implement the method for obtaining an energy spectrum disclosed in the present disclosure.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numbering indicates the same structure, wherein:

FIG. 1 is a schematic diagram illustrating an exemplary application scenario of a system for obtaining an energy spectrum according to some embodiments of the present disclosure;

FIG. 2 is a block diagram illustrating an exemplary system for obtaining an energy spectrum according to some embodiments of the present disclosure;

FIG. 3 is a flowchart illustrating an exemplary process for obtaining an energy spectrum according to some embodiments of the present disclosure;

FIG. 4a is a schematic diagram illustrating an acquisition of a first depth dose curve and/or a second depth dose curve according to some embodiments of the present disclosure;

FIG. 4b is a schematic diagram illustrating an exemplary first depth dose curve and an exemplary second depth dose curve according to some embodiments of the present disclosure;

FIG. 5 is a schematic diagram illustrating depth-based discretization of a first depth dose curve and a second depth dose curve according to some embodiments of the present disclosure; and

FIG. 6 is a flowchart illustrating an exemplary process for obtaining a first energy spectrum of a first depth dose curve according to some embodiments of the present disclosure.

### DETAILED DESCRIPTION

The technical solutions in the embodiments of the present disclosure will be clearly and completely described below in conjunction with the accompanying drawings in the embodiments of the present disclosure, and it is clear that the embodiments described are only a portion of the embodiments of the present disclosure, and not all of the embodiments. Based on the embodiments in the present disclosure, all other embodiments obtained by a person of ordinary skill in the art without making creative labor fall within the scope of protection of the present disclosure.

It should be noted that the terms “system,” “device,” “unit,” and/or “module” used in the present disclosure and in the claims are a way to distinguish between different components, elements, parts, sections, or assemblies at different levels. However, the words may be replaced by other expressions if other words accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to the embodiments described herein. It should be understood that the operations may not necessarily be performed in the exact sequence depicted. Instead, the operations may be performed in reverse order or concurrently. Additionally, other operations may be added to these processes, or one or more operations may be removed.

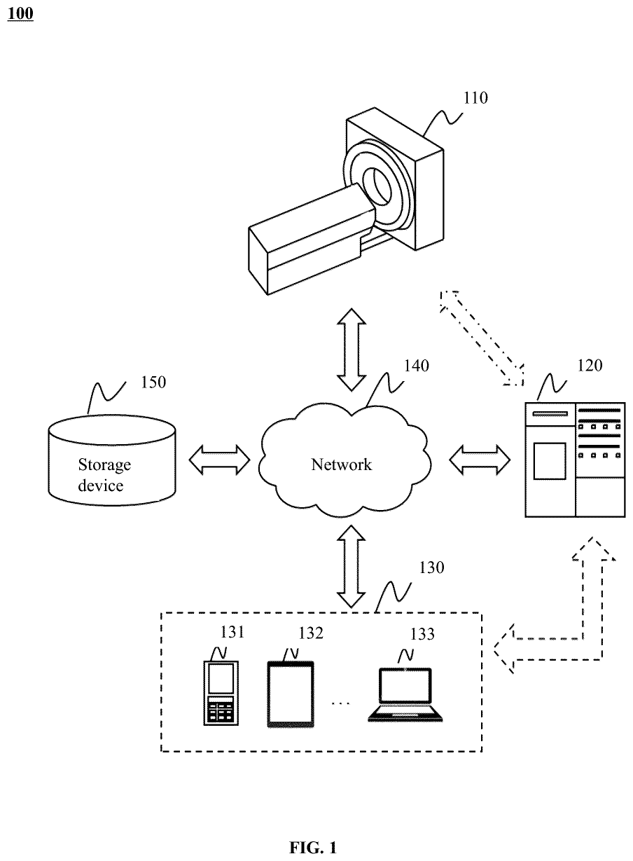

FIG. 1 is a schematic diagram illustrating an exemplary application scenario of a system for obtaining an energy spectrum according to some embodiments of the present disclosure.

The system for obtaining an energy spectrum (hereinafter referred to as the energy spectrum acquisition system) may acquire an energy spectrum of a multi-energy radiation beam by implementing the methods and/or processes disclosed herein. As shown in FIG. 1, an application scenario 100 may include a device 110, a processing device 120, at least one terminal device 130, a network 140, a storage device 150, or the like.

Components of the energy spectrum acquisition system may be connected in one or more different ways. Merely by way of example, the device 110 may be connected to the processing device 120 via the network 140, as shown in FIG. 1. As another example, the device 110 may be directly connected to the processing device 120 (as shown by the dashed bi-directional arrow connecting the device 110 to the processing device 120). As yet another example, the storage device 150 may be connected to the processing device 120 directly or through the network 140. As a further example, the at least one terminal device 130 may be connected to the processing device 120 directly (as indicated by the dashed bi-directional arrow connecting the at least one terminal device 130 to the processing device 120) and/or via the network 140.

The device 110 may utilize one or more radiation beams to treat and/or image a target object. In some embodiments, the device 110 may include a radiation source. In some embodiments, the radiation source may emit a radiation beam into a phantom. In some embodiments, the radiation beam may include a radioisotope (e.g., beta and gamma) ray beam, an x-ray beam, a photon beam, an electron beam, a heavy particle (e.g., proton and neutron) ray beam, or the like. In some embodiments, the device 110 may be a radiotherapy device that utilizes one or more radiation beams to treat a target object. For example, the device 110 may include an X-ray therapy machine, a gamma-ray afterloader, an electron accelerator, a neutron accelerator, a proton therapy machine, or the like. In some embodiments, the device 110 may be an imaging device that utilizes one or more radiation beams to image the target object. For example, the device 110 may include X-ray imaging equipment, electronic computed tomography (CT) imaging equipment, and cone beam computed tomography (CBCT) scanning equipment, or the like. In some embodiments, the energy spectrum acquisition system 200 may measure absorption doses to the radiation beams at different depths within the phantom using measurement equipment such as ionization chamber measurement equipment, semiconductor measurement equipment, or the like.

The processing device 120 may process data and/or information obtained from the device 110, the at least one terminal device 130, and/or the storage device 150. For example, the processing device 120 may obtain absorption doses to the radiation beams at different depths within the phantom from the device 110 and obtain a depth dose curve, such as a percentage depth dose (PDD) curve, or the like. For example, the processing device 120 may discretize a first depth dose curve and a second depth dose curve and determine a relationship between the first depth dose curve and the second depth dose curve. As another example, the processing device 120 may determine a second energy spectrum corresponding to the second depth dose curve. In some embodiments, the processing device 120 may include a central processing unit (CPU), a digital signal processor (DSP), a system on a chip (SoC), a microcontroller unit (MCU), or the like, or any combination thereof. In some embodiments, the processing device 120 may include a computer, a user console, a single server, a server group, etc. The server group may be centralized or distributed. In some embodiments, the processing device 120 may be local or remote. For example, the processing device 120 may access information and/or data stored in the device 110, the at least one terminal device 130, and/or the storage device 150 via the network 140. As another example, the processing device 120 may be directly connected to the device 110, the at least one terminal device 130, and/or the storage device 150 to access the stored information and/or data. In some embodiments, the processing device 120 may be implemented on a cloud platform. By way of example only, the cloud platform may include a private cloud, a public cloud, a hybrid cloud, a community cloud, a distributed cloud, an inter-cloud, a multi-cloud, or the like, or any combination thereof. In some embodiments, the processing device 120, or a portion of the processing device 120, may be integrated into the device 110.

The at least one terminal device 130 may display a depth dose curve and/or an energy spectrum of the radiation beam to the user. The at least one terminal device 130 may include a mobile device 131, a tablet computer 132, a laptop computer 133, or the like, or any combination thereof. In some embodiments, the at least one terminal device 130 may be part of the processing device 120.

The network 140 may include any suitable network that facilitates the exchange of information and/or data for the energy spectrum acquisition system. In some embodiments, one or more components (e.g., the device 110, the processing device 120, the storage device 150, and the at least one terminal device 130) of the energy spectrum acquisition system may communicate information and/or data with one or more other components of the energy spectrum acquisition system via network 140. For example, the processing device 120 may acquire a monoenergetic depth dose curve from the storage device 150 via the network. As another example, the at least one terminal device 130 may obtain the second energy spectrum corresponding to the second depth dose curve from the processing device 120 via the network 140. The network 140 may include a public network, a private network, a wide area network (WAN), a wired network, a wireless network, a cellular network, a frame relay network, a virtual private network, a satellite network, a telephony network, a router, a hub, a switch, a server computer, or the like, or any combination thereof. In some embodiments, the network 140 may include one or more network access points. For example, the network 140 may include a wired wireless network access point and/or a wireless network access point, such as a base station and/or an Internet exchange point, through which one or more components of the energy spectrum acquisition system may connect to network 140 to exchange data and/or information.

The storage device 150 may store data, instructions, and/or any other information. In some embodiments, the storage device 150 may store data obtained from the device 110, the at least one terminal device 130, and/or the processing device 120. In some embodiments, the storage device 150 may include mass storage, removable memory, volatile read-write memory, read-only memory (ROM), or the like, or any combination thereof. In some embodiments, the storage device 150 may execute on a cloud-based platform. In some embodiments, the storage device 150 may be connected to the network 140 to communicate with one or more other components (e.g., the device 110, the processing device 120, and the at least one terminal device 130) of the energy spectrum acquisition system. One or more components of the energy spectrum acquisition system may access data or instructions stored in the storage device 150 over the network 140. In some embodiments, the storage device 150 may be directly coupled to or in communication with one or more other components (e.g., the device 110, the processing device 120, and the at least one terminal device 130) of the energy spectrum acquisition system. In some embodiments, the storage device 150 may be part of the processing device 120.

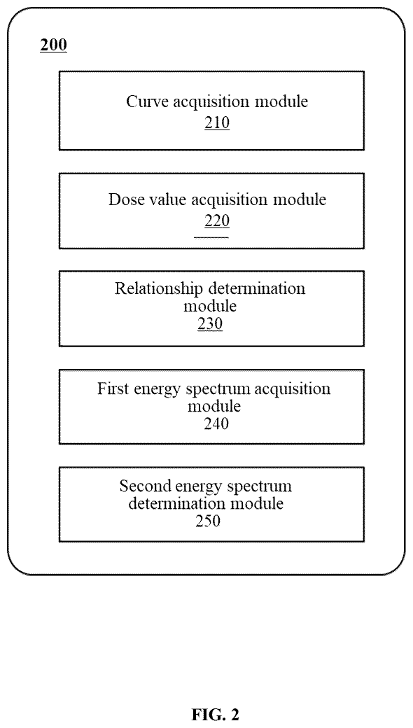

FIG. 2 is an exemplary block diagram illustrating a system for obtaining an energy spectrum according to some embodiments of the present disclosure. As shown in FIG. 2, the energy spectrum acquisition system 200 may include a curve acquisition module 210, a dose value acquisition module 220, a relationship determination module 230, a first energy spectrum acquisition module 240, and a second energy spectrum determination module 250.

The curve acquisition module 210 may be configured to obtain a first depth dose curve corresponding to a first energy and a second depth dose curve corresponding to a second energy. In some embodiments, the maximum measurement depth corresponding to the first depth dose curve and the maximum measurement depth corresponding to the second depth dose curve may be determined based on the thickness and/or material of the phantom. In some embodiments, the first energy may be no less than the second energy. A detailed description of the curve acquisition module 210 may be found in the description associated with operation 310 and will not be repeated herein.

The dose value acquisition module 220 may be configured to obtain, based on the first depth dose curve and the second depth dose curve, a first set of dose values and a second set of dose values along a depth direction, respectively. In some embodiments, the dose value acquisition module 220 may be used to perform one or more of the following operations: determining intervals of discrete points; determining the discrete points based on the maximum measurement depth and the intervals of discrete points; and obtaining the first set of dose values and the second set of dose values corresponding to the discrete points by discretizing the first depth dose curve and the second depth dose curve based on the discrete points. In some embodiments, the first set of dose values and the second set of dose values may be represented by a first vector and a second vector, respectively. A detailed description of the dose value acquisition module 220 may be found in the description related to operation 320 and will not be repeated herein.

The relationship determination module 230 may be configured to determine a relationship between the first depth dose curve and the second depth dose curve based on the first set of dose values and the second set of dose values. In some embodiments, the relationship determination module 230 may be configured to determine the relationship between the first depth dose curve and the second depth dose curve based on a ratio of at least one dose value in the first set of dose values to at least one dose value in the second set of dose values that corresponds to the at least one dose value in the first set of dose values. In some embodiments, the relationship between the first depth dose curve and the second depth dose curve may be represented by a diagonal matrix. In some embodiments, a non-zero element of each row in the diagonal matrix is determined based on a ratio of an element in a corresponding row in the second vector to an element in a corresponding row in the first vector. A detailed description of the relationship determination module 230 may be found in the description associated with operation 330 and will not be repeated herein.

The first energy spectrum acquisition module 240 may be configured to obtain a first energy spectrum corresponding to the first depth dose curve. In some embodiments, the first energy spectrum acquisition module 240 may be further configured to perform one or more of the following operations: determining a plurality of monoenergetic depth dose curves based on the first energy; and obtaining the first energy spectrum corresponding to the first depth dose curve based on the first depth dose curve and the plurality of monoenergetic depth dose curves. In some embodiments, the first energy spectrum acquisition module 240 is further configured to perform one or more of the following operations: determining monoenergetic energy intervals corresponding to the plurality of monoenergetic depth dose curves; and determining the plurality of monoenergetic depth dose curves based on the first energy and the monoenergetic energy intervals. In some embodiments, the first energy spectrum acquisition module 240 is further configured to perform one or more of the following operations: obtaining a phase space file by simulating the plurality of monoenergetic depth dose curves using a Monte Carlo algorithm; and obtaining the first energy spectrum corresponding to the first depth dose curve based on the phase space file and the first depth dose curve. A detailed description of the first energy spectrum acquisition module 240 may be found in the description related to operation 340 and will not be repeated herein.

The second energy spectrum determination module 250 may be configured to determine a second energy spectrum corresponding to the second depth dose curve based on the first energy spectrum and the relationship between the first depth dose curve and the second depth dose curve. A detailed description of the second energy spectrum determination module 250 may be found in the description associated with operation 350 and will not be repeated herein.

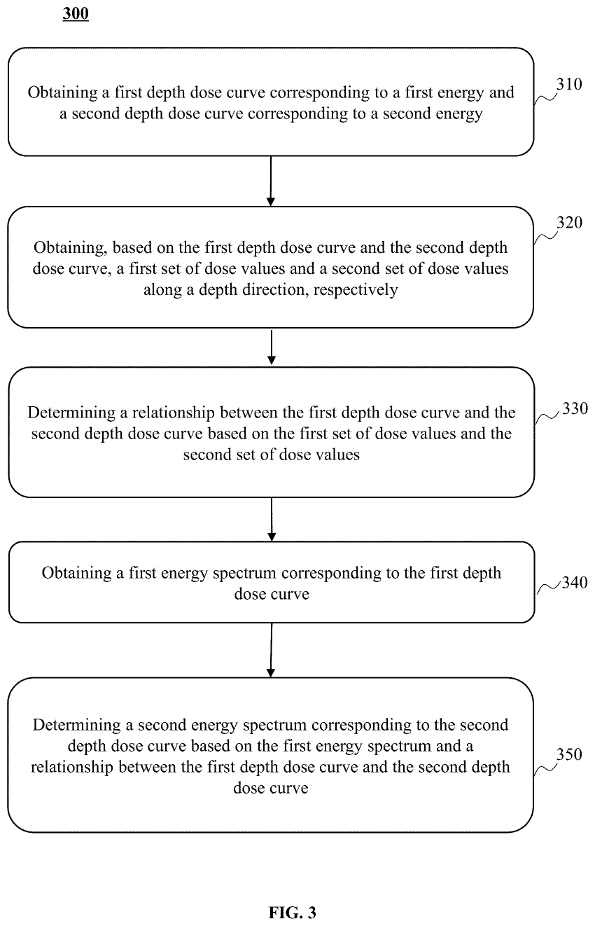

FIG. 3 is a flowchart illustrating an exemplary process for obtaining an energy spectrum according to some embodiments of the present disclosure. As shown in FIG. 3, process 300 includes the following operations.

In 310, a first depth dose curve corresponding to a first energy and a second depth dose curve corresponding to a second energy may be obtained. Operation 310 may be performed by the curve acquisition module 210.

A monoenergetic ray is a ray composed of particles of the same energy. For example, a monoenergetic ray X1, consisting of photons with an energy of 0.1 MeV, has an energy of 0.1 MeV.

A radiation beam used for radiotherapy and imaging may be a polyenergetic beam comprising a succession of particles of different energies. In some embodiments, the energy of the radiation beam may be obtained by performing a weighted summation on the energies of the different particles in the beam. It may be understood that, in some embodiments, the energy of the radiation beam may be obtained by superimposing monoenergetic rays of different energies based on corresponding weights.

An energy spectrum of the radiation beam may describe the energies of the particles contained in the beam and the weights corresponding to the particles. In some embodiments, the energy spectrum may be represented by a distribution curve of the weight of particles in the radiation beam along with the energy of the particles. Specifically, a horizontal axis and a vertical axis of the curve may represent the energies of the particles in the radiation beam and the weights corresponding to the particles, respectively. For example, the energy spectrum corresponding to a radiation beam with an energy of 5 MeV may include a distribution of weights of particles in the beam at energies ranging from 0 MeV to 5 MeV.

A first radiation beam refers to a radiation beam for measuring the energy spectrum of any other radiation beams.

The first energy refers to the energy of the first radiation beam. For example, the first radiation beam may be an X-ray beam I₁, and the first energy may be the energy of the X-ray beam I₁: 10 MeV.

A second radiation beam refers to a radiation beam of any energy spectrum to be measured. In some embodiments, types of the particles of the second radiation beam and the first radiation beam may be the same. For example, both the second radiation beam and the first radiation beam are X-ray beams. In some embodiments, the first radiation beam and the second radiation beam may be from the same or different devices. For example, both the first radiation beam and the second radiation beam are from a first device 111. As another example, the first radiation beam is from the first device 111 and the second radiation beam is from a second device 112.

The second energy refers to an energy corresponding to the second radiation beam. Continuing with the above example, the second radiation beam may be an X-ray beam I₂, and the second energy may be the energy of the X-ray beam I₂:5 MeV.

In some embodiments, the first energy may be not less than the second energy. For example, the first energy of 10 MeV is not less than the second energy of 5 MeV.

According to the above description, the first radiation beam may be used to measure the energy spectrum of the second radiation beam. Therefore, in some embodiments of the present disclosure, a range of energy magnitudes of the particles in the first radiation beam may be greater than a range of energy magnitudes of the particles in the second radiation beam, so that the energies of the particles in the second radiation beam may be described through the energies of the particles contained in the first radiation beam. Continuing with the above example, the X-ray beam I₁ corresponding to the first energy of 10 MeV may contain photons with energies in a range of 0 MeV to 10 MeV, and the X-ray beam I₂ corresponding to the second energy of 5 MeV may contain photons with energies in a range of 0 MeV to 5 MeV. Then the photons with energies in the range of 0 MeV to 5 MeV included in the X-ray beam I₁ may be used to describe the energies of the photons included in the X-ray beam I₂.

An absorption dose refers to the amount of radiant energy absorbed per unit mass of a phantom.

The phantom refers to a model used to substitute human tissue. In some embodiments, a material of the phantom may exhibit the same or similar absorption and scattering properties as human tissue to radiation beams. Exemplary materials include water, polystyrene, acrylic, paraffin, polyethylene, or the like. In some embodiments, the thickness of the phantom may be similar to the thickness of a human body. For example, the phantom may be a water phantom with a thickness of 40 cm.

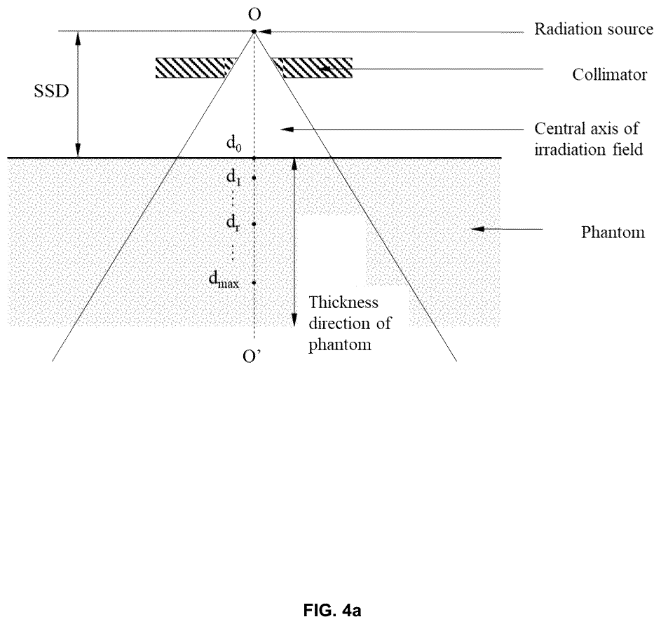

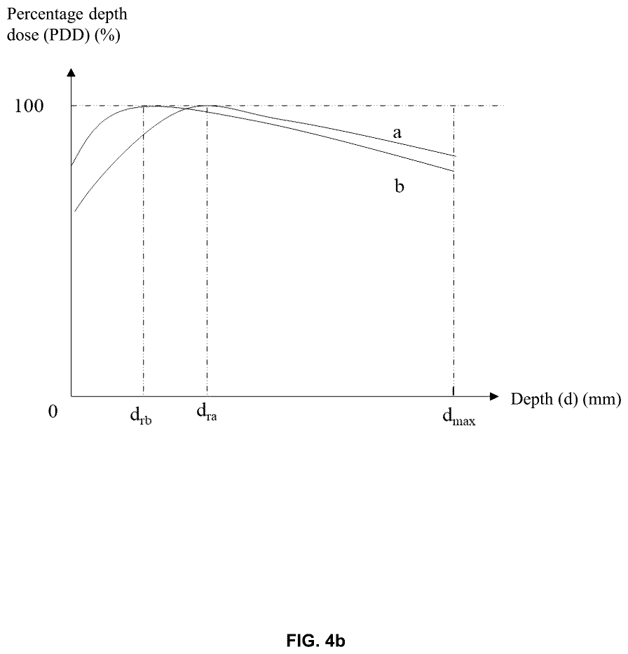

A central axis of an irradiation field within the phantom may be a central symmetric axis of the radiation beam. In some embodiments, the central axis of the irradiation field within the phantom may be parallel to the thickness direction of the phantom. FIG. 4a is a schematic diagram illustrating the acquisition of a first depth dose curve and/or a second depth dose curve according to some embodiments of the present disclosure. As shown in FIG. 4a, the center axis of the field OO′ is parallel to the thickness direction of the phantom, wherein the thickness direction of the phantom is a depth direction.

In some embodiments, the curve acquisition module 210 may measure the absorption dose at each depth along the central axis of the irradiation field within the phantom under the irradiation of the first radiation beam and the second radiation beam, respectively, under the same measurement condition.

In some embodiments, the measurement condition may include an irradiation field, a source to surface distance, a measurement technique, or the like. The irradiation field refers to an irradiation range of the phantom after the radiation beam passes through a collimator. In some embodiments, the curve acquisition module 210 may use the same collimator to acquire the same irradiation field. The source to surface distance (SSD) refers to a distance from a radiation source to a center of the irradiation field on a surface of the phantom. In some embodiments, the curve acquisition module 210 may measure the absorption dose at each depth along the central axis of the irradiation field within the phantom, corresponding to the first radiation beam and the second radiation beam, respectively, under the same SSD. In some embodiments, the measurement technique may include an ionization chamber measurement technique, a semiconductor measurement technique, a calorimetry technique, a chemical dosimetry technique, a thermoluminescence dosimetry technique, or the like.

By way of example, the curve acquisition module 210 may measure absorption doses at different depths within the phantom under the measurement conditions “SDS equals 30 cm, using collimator Z1, and based on the ionization chamber measurement technique” under the radiation of the first radiation beam and the second radiation beam. For example, the curve acquisition module 210 may measure absorption doses D₀^{a}, D₁^{a}, . . . , D_{rb}^{a}, . . . , Dᵣₐ^{a} respectively at depths d₀, d₁, . . . , d_{rb}, . . . , dᵣₐ, . . . within the phantom under the irradiation of the first radiation beam, using the measurement conditions “SDS equals 30 cm, using collimator Z1, and based on the semiconductor measurement technique.” Under the same measurement conditions, the curve acquisition module 210 may measure the absorption doses D₀^{a}, D₁^{a}, . . . , D_{rb}^{a}, . . . , Dᵣₐ^{a} respectively at depths d₀, d₁, . . . , d_{rb}, . . . , dᵣₐ, . . . within the phantom under the irradiation of the second radiation beam.

A depth dose may indicate the absorption doses at different depths within the phantom. In some embodiments, the depth dose may include a percentage depth dose (PDD). A percentage depth dose curve may represent the percentage of the absorption dose at a certain depth along the central axis of the irradiation field within the phantom to an absorption dose at a reference point.

The reference point may be a position along the central axis of the irradiation field within the phantom where the depth dose is determined to be 100%. If the energy of the radiation beam is less than 400 keV, the reference point may be located on the surface of the phantom, as shown in FIG. 4a, and the depth of the reference point located on the surface of the phantom, denoted as d₀, is 0 mm. If the energy of the radiation beam is larger than 400 keV, the reference point may be a point of maximum absorption dose on the center axis of the irradiation field, as shown in FIG. 4a, and the depth of the reference point (i.e., the point of maximum absorption dose) is dᵣ.

In some embodiments, the curve acquisition module 210 may take positions of the maximum absorption doses along the central axis of the irradiation field within the phantom under the irradiation of the first and second radiation beams as the first reference point and the second reference point, respectively.

Continuing with the above example, under the irradiation of the first radiation beam, the position corresponding to the maximum absorbed dose Dᵣₐ^{a} on the central axis of the irradiation field within the phantom may be designated as the first reference point. Under the irradiation of the second radiation beam, the position corresponding to the maximum absorbed dose D_{rb}^{b} on the central axis of the irradiation field within the phantom may be designated as the second reference point.

As another example, under the irradiation of a first radiation beam with an energy less than 400 keV, the position corresponding to the maximum absorbed dose D₀^{a} on the central axis of the irradiation field within the phantom may be designated as the first reference point. Under the irradiation of a second radiation beam with an energy greater than 400 keV, the position corresponding to the maximum absorbed dose D_{rb}^{b} on the central axis of the irradiation field within the phantom may be designated as the second reference point.

According to the above description, the selection criteria for the first reference point corresponding to the first radiation beam and the second reference point corresponding to the second radiation beam may be the same or different.

Further, in some embodiments, the curve acquisition module 210 may determine a percentage depth dose at each depth based on the absorption dose at the depth and the absorption dose corresponding to the reference point. For example, the percentage depth doses corresponding to the depths d₀, d₁, . . . , d_{rb}, . . . , dᵣₐ, . . . on the center axis of the irradiation field of the first radiation beam are (D₀^{a}/Dᵣₐ^{a})×100%, (D₁^{a}/Dᵣₐ^{a})×100% . . . (D_{rb}^{a}/Dᵣₐ^{a})×100% . . . (Dᵣₐ^{a}/Dᵣₐ^{a})×100% . . . , respectively. The percentage depth doses corresponding to the depths d₀, d₁, . . . , d_{rb}, . . . , dᵣₐ, . . . on the center axis of the irradiation field of the second radiation beam are Dob/Drbb)×100%, (D₁^{b}/D_{rb}^{b})×100% . . . (D_{rb}^{b}/D_{rb}^{b})×100% . . . (Dᵣₐ^{b}/D_{rb}^{b})×100% . . . , respectively.

A depth dose curve refers to a curve that describes a variation of the depth dose within the irradiated phantom as a function of depth. In some embodiments, the depth dose curve may include a percentage depth dose (PDD) curve. Specifically, a horizontal axis of the PDD curve may represent a depth from the surface of the phantom along the central axis of the irradiation field, and a vertical axis of the PDD curve may represent the percentage depth dose.

The first depth dose curve is a curve that describes the variation of the depth dose within the phantom irradiated by the first radiation beam as a function of depth. FIG. 4b is a schematic diagram illustrating an exemplary first depth dose curve and an exemplary second depth dose curve according to some embodiments of the present disclosure. As shown in FIG. 4b, the first depth dose curve corresponding to the X-ray beam I₁ (e.g., the first radiation beam) is curve a, where dᵣ^{a} denotes the depth corresponding to the maximum dose of the phantom irradiated by the X-ray beam I₁.

The second depth dose curve is a curve that describes the variation of the depth dose within the phantom irradiated by the second radiation beam as a function of depth. As shown in FIG. 4b, the second depth dose curve corresponding to the X-ray beam I₂ (e.g., the second radiation beam) is curve b, where dᵣ^{b} denotes the depth corresponding to the maximum dose of the phantom irradiated by the X-ray beam I₂.

A maximum measurement depth refers to a maximum depth within a measurement range of the absorption dose, i.e., the maximum value corresponding to the horizontal coordinate of the depth dose curve.

It should be understood that the radiation beam propagates in the thickness direction of the phantom and may be scattered at a bottom portion of the phantom (e.g., the radiation beam is scattered when the radiation beam is incident on the phantom wall), which may lead to inaccurate measurement of the absorption dose at the bottom portion of the phantom. Optionally, the maximum measurement depth may be less than the thickness of the phantom. For example, the maximum measurement depth may be less than the thickness of the phantom by 5 cm.

In some embodiments, if the maximum measurement depths corresponding to the first depth dose curve and the second depth dose curve are different, the smaller value may be taken as the maximum measurement depth. For example, if the maximum measurement depth corresponding to the first depth dose curve is 30 cm and the maximum measurement depth corresponding to the second depth dose curve is 35 cm, then 30 cm may be taken as the maximum measurement depth for both the first depth dose curve and the second depth dose curve.

Some embodiments of the present disclosure determine the maximum measurement depth corresponding to the first depth dose curve and the second depth dose curve based on the thickness and/or the material of the phantom, which ensures that the absorbed dose within the measurement range of the phantom is not deficient due to scattering, thereby reducing an effect of scattering on the measurement of the first depth dose curve and the second depth dose curve.

In 320, a first set of dose values and a second set of dose values along a depth direction may be obtained based on the first depth dose curve and the second depth dose curve, respectively. Operation 320 may be performed by the dose value acquisition module 220.

In some embodiments, the dose value acquisition module 220 may be configured to obtain the first set of dose values and the second set of dose values corresponding by discretizing the first depth dose curve and the second depth dose curve.

Discrete point refers to points corresponding to discrete depths on a depth dose curve (e.g., the first depth dose curve and/or the second depth dose curve).

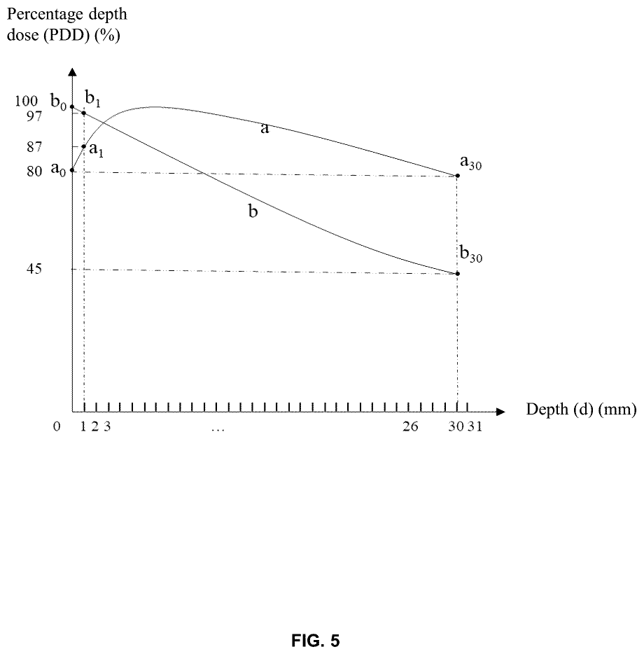

In some embodiments, a horizontal coordinate of a discrete point may be a discrete depth and a vertical coordinate of the discrete point may be a depth dose (e.g., a percentage depth dose) corresponding to the discrete depth. FIG. 5 is a schematic diagram illustrating depth-based discretization of a first depth dose curve and a second depth dose curve according to some embodiments of the present disclosure. As shown in FIG. 5, the horizontal coordinate of a discrete point a1 is a discrete depth of 1 cm, and the vertical coordinate of the discrete point a1 is the percentage depth dose 87% corresponding to the 1 cm on a first depth dose curve a. The horizontal coordinate of a discrete point b1 is a discrete depth of 1 cm, and the vertical coordinate of the discrete point b1 is a percentage depth dose of 97% corresponding to 1 cm on a second depth dose curve b.

Discretization refers to representing infinite, consecutive points on a depth dose curve (e.g., the first depth dose curve and/or the second depth dose curve) with finite discrete points. For example, the infinite, continuous points on the curve a may be represented by m discrete points on the curve a.

An interval of discrete points refers to an interval between two adjacent discrete points in horizontal coordinates, i.e., the interval between two adjacent discrete points in depth.

In some embodiments, the dose value acquisition module 220 may determine intervals of discrete points based on a discretization precision and/or a discretization speed.

The discretization precision refers to a parameter for assessing the degree of discretization of the depth dose curve. It may be understood that the higher the discretization precision, the higher the count of discrete points used to represent the same depth range, and the closer a first vector and/or a second vector obtained to the first depth dose curve and/or the second depth dose curve. A detailed description of the first vector and the second vector is provided below and will not be repeated herein.

In some embodiments, the discretization precision may represent a ratio of the interval of discrete points to a depth measurement range. For example, a discretization precision of 0.03 indicates that the ratio of the interval of discrete points to the depth measurement range is 0.03. In some embodiments, the dose value acquisition module 220 may determine the interval of discrete points based on a product of the discretization precision and the depth measurement range. For example, if the discretization precision is 0.03 and the depth measurement range is 30 cm, the interval of discrete points is 0.9 cm.

The discretization speed refers to a parameter for evaluating a rate of discretization of a depth dose curve. In some embodiments, the discretization speed may indicate the time it takes to complete one discretization of the depth dose curve. For example, the discretization speed may include 1s, indicating that it takes 1s to complete a depth-based discretization of the depth dose curve. In some embodiments, the dose value acquisition module 220 may determine an initial count of discrete points based on the discretization speed, thereby determining the intervals of discrete points. Specifically, the dose value acquisition module 220 may pre-obtain a first relationship curve of the discretization speed and the initial count of discrete points, and then determine the initial count of discrete points based on the discretization speed and the first relationship curve. The dose value acquisition module 220 may determine the interval of discrete points based on the depth measurement range and the initial count of discrete points. For example, if the discretization speed is 1 s, and the corresponding initial count of discrete points is 31, the interval of discrete points may be determined to be 1 cm by dividing the depth measurement range of 30 by a difference obtained after subtracting 1 from the initial count (i.e., 30) of discrete points.

In some embodiments of the present disclosure, the dose value acquisition module 220 may average the interval of discrete points determined based on the discretization precision and the interval of discrete points determined based on the discretization speed to determine the final interval of discrete points. For example, the dose value acquisition module 220 may average 0.9 cm and 1 cm, thereby determining a final discrete interval of 0.95 cm.

In some embodiments of the present disclosure, the discretization precision and/or the discretization speed may be determined based on user input.

In some embodiments, the dose value acquisition module 220 may be configured to determine an acquisition method of the interval of discrete points based on the parameters input by the user, and then determine the interval of discrete points. For example, if the user only enters a discretization precision of “0.03,” the dose value acquisition module 220 may determine that the interval of discrete points is the interval of discrete points of 1 cm determined based on the discretization precision.

In some embodiments of the present disclosure, the discretization precision and/or the discretization speed may be default values set in advance.

In some embodiments of the present disclosure, the dose value acquisition module 220 may obtain a user-input interval of discrete points from the at least one terminal device 130 and determine whether the interval of discrete points input by the user satisfies the discretization precision and/or the discretization speed. For example, if the interval of discrete points input by the user does not satisfy the discretization precision and/or the discretization speed, the dose value acquisition module 220 may prompt the user on the at least one terminal device 130 to re-enter the interval of discrete points or directly display a recommended interval of discrete points to the user based on the discretization precision and/or the discretization speed.

According to the above description, the maximum measurement depth of the first depth dose curve and the maximum measurement depth of the second depth dose curve are the same, so the depth measurement range of the first depth dose curve is the same as the depth measurement range of the second depth dose curve. Therefore, in some embodiments of the present disclosure, based on the same discretization precision and discretization speed, the intervals of discrete points of the first depth dose curve and the second depth dose curve may be the same.

Further, in some embodiments of the present disclosure, the dose value acquisition module 220 may determine the discrete points based on the maximum measurement depth and the interval of discrete points.

Specifically, the dose value acquisition module 220 may designate 0 cm as the horizontal coordinate of a first discrete point, sequentially determine a plurality of horizontal coordinates based on the interval of discrete points until the horizontal coordinate exceeds the maximum measurement depth, and determine a plurality of horizontal coordinates that do not exceed the maximum measurement depth as the horizontal coordinates of the discrete points, thereby determining the discrete points of the depth dose curve (e.g., the first depth dose curve and/or the second depth dose curve).

According to the above description, the first depth dose curve and the second depth dose curve have the same maximum measurement depth and the interval of discrete points. Therefore, in some embodiments of the present disclosure, the counts of discrete points and the horizontal coordinates of each discrete point may be the same for the first depth dose curve and the second depth dose curve. In some embodiments of the present disclosure, the first depth dose curve and the second depth dose curve may be discretized in the same way or differently, as long as it is ensured that the counts of discrete points of the first depth dose curve and the second depth dose curve are the same.

As shown in FIG. 5, 0 cm is taken as the horizontal coordinate of the first discrete point, and based on the interval of discrete points of 1 cm, the following horizontal coordinates may be determined sequentially: 0, 1, 2, 3 . . . 30, and 31 cm. The horizontal coordinate of 31 cm is greater than the maximum measurement depth of 30 cm, so the horizontal coordinates 0, 1, 2, 3 . . . 30 cm are taken as the horizontal coordinates of the first depth dose curve a and the horizontal coordinates of the second depth dose curve b. Thus, the m (m=31) discrete points of the curve a: a0 (0, 80), a1 (1, 87), . . . a30 (30, 80), and the m (m=31) discrete points of the curve b: b0 (0, 100), b1 (1, 97), . . . b30 (30, 45) are determined.

Furthermore, in some embodiments of the present disclosure, the dose value acquisition module 220 may be configured to obtain the first set of dose values and the second set of dose values by discretizing the first depth dose curve and the second depth dose curve based on the discrete points.

The first set of dose values refers to a collection of dose values that represent the first depth dose curve through dose depths corresponding to the discrete points on the first depth dose curve. In some embodiments of the present disclosure, the dose values in the first set of dose values may be the vertical coordinates of discrete points on the first depth dose curve. A count of dose values in the first set of dose values may be the same as the count of the discrete points on the first depth dose curve. By way of example, if the count of discrete points on the first depth dose curve is m, the count of dose values in the first set of dose values is m. For example, as shown in FIG. 5, the first set of dose values may include the vertical coordinates [80, 87, . . . , 80] corresponding to the 31 discrete points on the curve a.

In some embodiments of the present disclosure, the first set of dose values may be represented by a first vector. A dimension of the first vector may be the same as the count of the discrete points on the first depth dose curve. By way of example, if the count of the discrete points on the first depth dose curve is m, the dimension of the first vector is m×1. For example, referring to FIG. 5, elements of the first vector may be the vertical coordinates of 31 discrete points, a0 (0, 80), a1 (1, 87), . . . , a30 (30, 80), on the curve a, then the first vector A= [80,87, . . . ,80] T, and the first vector is a 31-dimensional vector.

The second set of dose values refers to a collection of dose values that represents the second depth dose curve through dose depths corresponding to the discrete points on the second depth dose curve. In some embodiments of the present disclosure, dose values in the second set of dose values may be the vertical coordinates of the discrete points on the second depth dose curve. A count of dose values of the second set of dose values may be the same as the count of the discrete points on the second depth dose curve. By way of example, if the count of the discrete points on the second depth dose curve is m, the count of dose values of the second set of dose values is m. For example, as shown in FIG. 5, the second set of dose values may include the vertical coordinates [100,97, . . . ,45] corresponding to the 31 discrete points on the curve b.

In some embodiments, the second set of dose values may be represented by a second vector. The second vector may be a vector that represents the second depth dose curve through percentage dose depths corresponding to the discrete points on the second depth dose curve. Similarly to the first vector, a dimension of the second vector may be the same as the count of the discrete points on the second depth dose curve. By way of example, if the count of the discrete points on the second depth dose curve is m, the dimension of the second vector is m×1. For example, referring to FIG. 5, elements of the second vector may be the vertical coordinates of 31 discrete points, b0 (0, 100), b1 (1, 97), . . . , b30 (30, 45), on the curve b, then the second vector B= [100,97, . . . ,45] T, and the second vector is a 31-dimensional vector.

According to the above description, the first vector and the second vector have the same dimension if the counts of the discrete points on the first depth dose curve and the second depth dose curve are the same. For example, if the first depth dose curve and the second depth dose curve each contains 31 discrete points, the first vector A and the second vector B both have a dimension of 31.

It may be understood that the smaller the discretization precision is and the slower the discretization speed is, the smaller the interval of discrete points is, thus the larger the count of discrete points is, then the higher the dimension of the corresponding first second vector and/or second vector, and the lower the overall computational efficiency of the system.

Some embodiments of the present disclosure determine the interval of discrete points based on the discretization precision and/or the discretization speed, and determine the discrete points based on the interval of discrete points. This ensures that the first set of dose values and the second set of dose values accurately represent the first depth dose curve and second depth dose curve, respectively. Additionally, by limiting the dimension of the first set of dose values and the dimension of the second set of dose values in the count of rows based on the discretization speed, the overall computational efficiency of the system can be improved.

In some embodiments, the dose value acquisition module 220 may utilize a discretion model to obtain the first set of dose values and the second set of dose values based on the first depth dose curve and the second depth dose curve, respectively.

Specifically, the dose value acquisition module 220 may input the first depth dose curve and the second depth dose curve into the discretion model, and the discretion model may output the first set of dose values and the second set of dose values, respectively. In some embodiments, an input of the discretion model may include the discretization precision and/or the discretization speed.

In some embodiments, the discretion model may include a support vector machine model, a logistic regression model, a plain Bayesian classification model, a Gaussian distributed Bayesian classification model, a decision tree model, a random forest model, a KNN classification model, a neural network model, or the like.

In some embodiments, the discretion model may be trained based on a large number of labeled training samples. Specifically, the labeled training samples are input into the discretion model, and the parameters of the discretion model are updated through training. In some embodiments, the training samples may include sample depth dose curves. In some embodiments, the labels may be manually labeled sample arrays.

In some embodiments, the first depth dose curve and the second depth dose curve may be discretized in the same manner. For example, the first depth dose curve and the second depth dose curve may both be discretized in a manner based on the interval of discrete points. In some embodiments, the first depth dose curve and the second depth dose curve may be discretized in different manners. For example, the first depth dose curve may be discretized based on the interval of discrete points and the second depth dose curve may be discretized based on the discretion model.

In 330, a relationship between the first depth dose curve and the second depth dose curve may be determined based on the first set of dose values and the second set of dose values. Operation 330 may be performed by the relationship determination module 230.

The relationship between the first depth dose curve and the second depth dose curve may be a transformation relationship between the first depth dose curve and the second depth dose curve. In some embodiments, the relationship determination module 230 may determine the relationship between the first depth dose curve and the second depth dose curve based on a ratio of at least one dose value in the first set of dose values to at least one dose value in the second set of dose values that corresponds to the at least one dose value in the first set of dose values.

In some embodiments, the relationship between the first depth dose curve and the second depth dose curve may be expressed by relational data.

In some embodiments, each value in the relational data may be determined based on a ratio of the dose value of a corresponding discrete point in the first set of dose values to a dose value of the corresponding discrete point in the second set of dose values. Continuing with the above example, a first value in the relational data may be the ratio of a first dose value (100) corresponding to the first discrete point in the second set of dose values [100, 97, . . . , 45] to a first dose value (80) corresponding to the first discrete point in the first set of dose values [80, 87, . . . , 80], which is 1.25. A second value in the relational data may be a ratio of a second dose value (97) corresponding to the second discrete point in the second set of dose values to a second dose value (87) corresponding to the second discrete point in the first set of dose values, which is 1.11. In the same manner, an m^{th} value in the relational data may be the ratio of an m^{th} dose value (45) corresponding to the m^{th} discrete point in the second set of dose values to an m^{th} dose value (80) corresponding to the m^{th} discrete point in the first set of dose values, which is 0.56. In other words, the relational data may be [1.25, 1.11, . . . , 0.56].

In some embodiments, the relational data (i.e., the relationship between the first depth dose curve and the second depth dose curve) may be represented by a diagonal matrix. Continuing with the above example, the relationship between curve a and curve b may be represented by a diagonal matrix C. In some embodiments, the relationship between the first vector, the second vector, and the diagonal matrix may be expressed in Equation (1):

$$B = [ \begin{matrix}{C}_{1 , 1} & 0 & 0 & 0 \\ 0 & {C}_{2 , 2} & 0 & 0 \\ 0 & 0 & … & 0 \\ 0 & 0 & 0 & {C}_{m , m}\end{matrix} ] \cdot A , \qquad ( 1 )$$

wherein A denotes the first vector, B denotes the second vector, diag (C_{1,1}, C_{2,2}, . . . , C_{m,m}) denotes the diagonal matrix.

In some embodiments, a count of rows and a count of columns in the diagonal matrix may be the same as the dimension of the first vector and/or the dimension of the second vector. By way of example, if the dimension of the first vector and the dimension of the second vector are m, a dimension of the diagonal matrix is m×m. For example, the first vector and the second vector are both 31-dimensional vectors, and the diagonal matrix has a dimension of 31×31.

In some embodiments, a non-zero element of each row in the diagonal matrix is determined based on a ratio of an element in a corresponding row in the second vector to an element in a corresponding row in the first vector. For example, if the first vector A= [80,87, . . . ,80] T, and the second vector B= [100,97, . . . ,45] T, then the non-zero element C_{1,1} in a first row of the diagonal matrix may be determined as 1.25 based on the ratio of an element (i.e., 100) in a first row of the second vector B to an element (i.e., 80) in a first row of the first vector A. The non-zero element C_{2,2} in a second row of the diagonal matrix may be determined as 1.11 based on the ratio of an element (i.e., 97) in a second row of the second vector B to an element (i.e., 87) in a second row of the first vector A. In the same manner, the non-zero element C_{31,31} in a 31^{st} row of the diagonal matrix may be determined as 0.56 based on the ratio of a 31^{st} element (i.e., 45) in a 31^{st} row of the second vector B to a 31^{st} element (i.e., 80) in a 31^{st} row of the first vector B. Thus, the diagonal matrix is determined as: C=diag (1.25, 1.11, . . . , 0.56).

Some embodiments of the present disclosure obtain a depth dose (e.g., a percentage depth dose) corresponding to the first depth dose curve and a depth dose (e.g., a percentage depth dose) corresponding to the second depth dose curve respectively based on the same measurement depth interval (i.e., an interval of discrete points). The relationship between the first vector and the second vector is expressed using a diagonal matrix, where the non-zero element of each row in the diagonal matrix is determined based on the ratio of an element in a corresponding row in the second vector to an element in a corresponding row in the first vector. This approach simplifies the relationship between the first depth dose curve and the second depth dose curve through a straightforward vector operation between the first vector and the second vector, improving the efficiency of subsequent determination of a second energy spectrum.

In 340, a first energy spectrum corresponding to the first depth dose curve may be obtained based on the first depth dose curve. Operation 340 may be performed by the first energy spectrum acquisition module 240.

As mentioned above, the energy spectrum of a radiation beam is a description of the energies and weights of the particles contained in the radiation beam.

The first energy spectrum is a description of the energies and first weights of the particles contained in the first radiation beam.

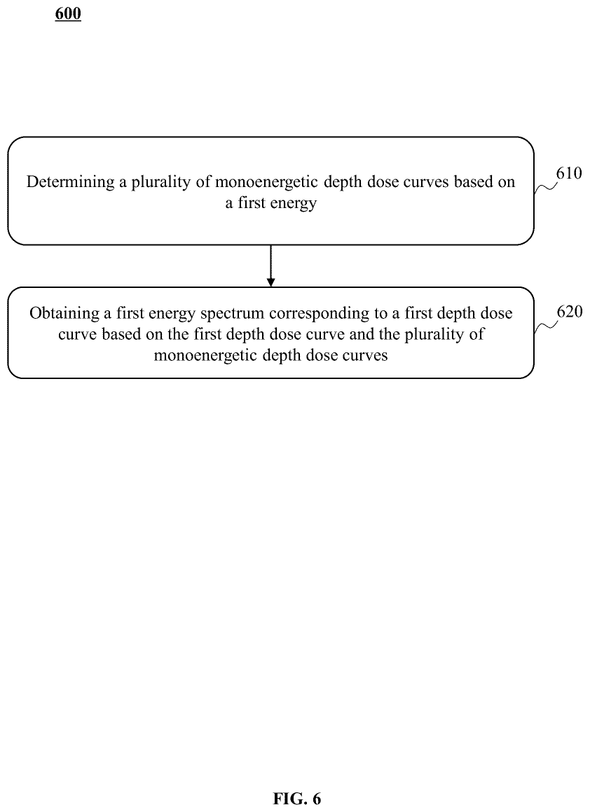

In some implementations, the first energy spectrum acquisition module 240 may determine a plurality of monoenergetic depth dose curves based on the first energy, and obtain the first energy spectrum corresponding to the first depth dose curve based on the first depth dose curve and the plurality of monoenergetic depth dose curves. For example, the first energy spectrum of the first depth dose curve may include first weights corresponding to 100 monoenergetic energies: 0.5% monoenergetic energy of 0.1 MeV, 1% monoenergetic energy of 0.2 MeV, . . . , 0.2% monoenergetic energy of 10 MeV. Detailed descriptions of obtaining the first energy spectrum of the first depth dose curve may be found in FIG. 6 and its related descriptions, and will not be repeated here.

In 350, a second energy spectrum corresponding to the second depth dose curve may be determined based on the first energy spectrum and the relationship between the first depth dose curve and the second depth dose curve. Operation 350 may be performed by the second energy spectrum determination module 250.

The second energy spectrum is a description of monoenergetic energies contained in the second radiation beam and second weights corresponding to the monoenergetic energies.

In some embodiments, a relationship between a second weight corresponding to a monoenergetic energy, a monoenergetic depth dose curve corresponding to the monoenergetic energy, and the second depth dose curve corresponding to the second radiation beam may be expressed by Equation (2):

$${PDD}^{b} = {\sum }_{i = 1}^{n} {ω}_{i}^{b} {PDD}_{i} , \qquad ( 2 )$$

wherein PDD^{b} denotes the second depth dose curve, n denotes an n^{th} monoenergetic depth dose curve, PDDᵢ denotes an i^{th} monoenergetic depth dose curve, and ωᵢ^{b} denotes the second weight of the depth dose (e.g., the percentage depth dose) corresponding to the i^{th} monoenergetic depth dose curve in the depth dose corresponding to the second depth dose curve (e.g., the percentage depth dose). More descriptions of the monoenergetic depth dose curve may be found in operation 610 and the relevant descriptions thereof and will not be repeated herein.

From Eq. (2), based on the second weights corresponding to the monoenergetic energies, depth doses (e.g., percentage depth doses) corresponding to a same depth on multiple monoenergetic depth dose curves is weighted and summed such that the depth dose (e.g., percentage depth dose) corresponding to the depth on the second depth dose curve may be obtained. The second weight corresponding to each monoenergetic energy may indicate the contribution of the corresponding monoenergetic ray to the depth dose (e.g., percentage depth dose) of the phantom in the second radiation beam.

According to the above description, the first energy spectrum of the first depth dose curve may be determined based on a plurality of first weights of depth doses (e.g., percentage depth doses) corresponding to a plurality of monoenergetic depth dose curves, respectively, in the depth doses (e.g., percentage depth doses) corresponding to the first depth dose curve, and the relationship between the first depth dose curve and the second depth dose curve may be expressed by the relationship between the first vector and the second vector. Therefore, in some embodiments, the second energy spectrum determination module 250 may represent the first vector and the second vector with the plurality of monoenergetic depth dose curves, respectively, so as to obtain, based on the first energy spectrum of the first depth dose curve, a plurality of second depth doses (e.g., percentage depth doses) corresponding to the plurality of monoenergetic depth dose curves, respectively, in the depth doses (e.g., percentage depth doses) corresponding to the second depth dose curves.

In some embodiments, the second energy spectrum determination module 250 may determine discrete points based on the same interval of discrete points as that on the first depth dose curve and/or the second depth dose curve, and discretize a plurality of monoenergetic depth dose curves based on the discrete points. Specifically, the second energy spectrum determination module 250 may represent each of n monoenergetic depth dose curves with a plurality of discrete points. A detailed description of the discrete points may be found in the description associated with operation 320 and will not be repeated herein.

In some embodiments, a count of discrete points on each monoenergetic depth dose curve may be the same as the count of the discrete points on the first depth dose curve and/or the second depth dose curve, and the horizontal coordinates of the discrete points on each monoenergetic depth dose curve may be the same as the horizontal coordinates of the discrete points on the first depth dose curve and/or the second depth dose curve. By way of example, the horizontal coordinates of the m=31 discrete points on the first depth dose curve and/or the second depth dose curve are 0 cm, 1 cm, . . . 30 cm, respectively, then the second energy spectrum determination module 250 may obtain 31 discrete points corresponding to n (e.g., 100) monoenergetic depth dose curves, respectively, based on the 31 horizontal coordinates. For example, 31 discrete points on a monoenergetic depth dose curve E1 corresponding to 0.1 MeV are: e1,0 (0, 40), e1,1 (1, 42), . . . e1,30 (30, 45); 31 discrete points on a monoenergetic depth dose curve E2 corresponding to 0.2 MeV are: e2,0 (0, 50), e2,1 (1, 54), . . . e2,30 (30, 55), . . . , 31 discrete points on a monoenergetic depth dose curve E100 corresponding to 10 MeV are: e100,0 (0, 90), e100,1 (1, 92), . . . e100,30 (30, 96).

A monoenergetic vector refers to a vector representing a monoenergetic depth dose curve using percentage dose depths corresponding to discrete points on the monoenergetic depth dose curve. In some embodiments, elements of the monoenergetic vector may be vertical coordinates of the discrete points on the monoenergetic depth dose curve, and a dimension of the monoenergetic vector may be the same as a count of the discrete points on the monoenergetic depth dose curve. By way of example, if the count of the discrete points on the monoenergetic depth-dose curve is m, the dimension of the monoenergetic vector is m×1.

In some embodiments, the second energy spectrum determination module 250 may represent a monoenergetic vector corresponding to a monoenergetic depth dose curve using Equation (3):

$${D}_{i} = [ \begin{matrix}{e}_{i , 0}^{y} \\ {e}_{i , 1}^{y} \\ ⋯ \\ {e}_{i , m}^{y}\end{matrix} ] , \qquad ( 3 )$$

wherein Dᵢ denotes the monoenergetic vector corresponding to an i^{th} monoenergetic depth dose curve, and e_{i,0}^{y}, e_{i,1}^{y} . . . e_{i,m}^{y} denote the vertical coordinates of a 1^{st}, 2^{nd} . . . m^{th} discrete point (i.e., the depth doses corresponding to the discrete points) on the i^{th} monoenergetic depth dose curve, respectively.

By way of example, the 1^{st} monoenergetic depth dose curve E1 corresponds to the monoenergetic vector D₁=[40 42 . . . 45] T, the 2^{nd} monoenergetic depth dose curve E2 corresponds to the monoenergetic vector D₂=[50 54 . . . 55]^{T}, . . . , the 100th monoenergetic depth dose curve E100 corresponds to the monoenergetic vector D₁₀₀= [90 92 . . . 96]^{T}.

In some embodiments, the second energy spectrum determination module 250 may represent the first vector with monoenergetic vectors based on a relationship between the monoenergetic depth dose curves and the first depth dose curve corresponding to the first radiation beam. A detailed description of the relationship between the monoenergetic depth dose curves and the first depth dose curve corresponding to the first radiation beam may be found in the relevant description of Equation (8) in operation 620, and will not be repeated herein.

In some embodiments, the second energy spectrum determination module 250 may represent the first vector with monoenergetic vectors according to Equation (4):

$$A = {ω}_{1}^{a} {D}_{1} + {ω}_{2}^{a} {D}_{2} + ⋯ + {ω}_{n}^{a} {D}_{n} = [ \begin{matrix}{D}_{1} & {D}_{2} & … & {D}_{n}\end{matrix} ] [ \begin{matrix}{ω}_{1}^{a} \\ {ω}_{2}^{a} \\ ⋯ \\ {ω}_{n}^{a}\end{matrix} ] , \qquad ( 4 )$$

wherein A denotes the first vector corresponding to the first depth dose curve, D₁, D₂ . . . . Dₙ are the monoenergetic vectors corresponding to the 1^{st} monoenergetic depth dose curve, the 2^{nd} monoenergetic depth dose curve, . . . , the n^{th} monoenergetic depth dose curve, respectively, and ω₁^{a}, ω₂^{a} . . . ωₙ^{a} denote first weights of the depth doses (e.g., percentage depth doses) corresponding to the 1^{st} monoenergetic depth dose curve, the 2^{nd} monoenergetic depth dose curve . . . the n^{th} monoenergetic depth dose curve in the depth doses (e.g., percentage depth doses) corresponding to the first depth dose curve.

In some embodiments, the second energy spectrum determination module 250 may represent the second vector through monoenergetic vectors based on a relationship between monoenergetic depth dose curves and a second depth dose curve corresponding to the second radiation beam. A detailed description of the relationship between the monoenergetic depth dose curves and the second depth dose curve corresponding to the second radiation beam may be found in the relevant description of Equation (2), which will not be repeated here.

In some embodiments, the second energy spectrum determination module 250 may represent the second vector with monoenergetic vectors according to Equation (5):

$$B = {ω}_{1}^{b} {D}_{1} + {ω}_{2}^{b} {D}_{2} + ⋯ + {ω}_{n}^{b} {D}_{n} = [ \begin{matrix}{D}_{1} & {D}_{2} & … & {D}_{n}\end{matrix} ] [ \begin{matrix}{ω}_{1}^{b} \\ {ω}_{2}^{b} \\ ⋯ \\ {ω}_{n}^{b}\end{matrix} ] , \qquad ( 5 )$$

wherein B denotes the second vector corresponding to the second depth dose curve, D₁, D₂ . . . Dₙ are the monoenergetic vectors corresponding to the 1^{st} monoenergetic depth dose curve, the 2^{nd} monoenergetic depth dose curve . . . the n^{th} monoenergetic depth dose curve, respectively, and ω₁^{b}, ω₂^{b} . . . ωₙ^{b} denote the second weights of the depth doses (e.g., percentage depth doses) corresponding to the 1^{st} monoenergetic depth dose curve, the 2^{nd} monoenergetic depth dose curve . . . the n^{th} monoenergetic depth dose curve in the depth doses (e.g., percentage depth doses) corresponding to the second depth dose curve.

Further, in some embodiments, the second energy spectrum determination module 250 may represent the relationship between the first depth dose curve and the second depth dose curve through monoenergetic vectors of monoenergetic depth dose curves. Specifically, in some embodiments, the second energy spectrum determination module 250 may substitute Equation (4) which represents the first vector with monoenergetic vectors and Equation (5) which represents the second vector with monoenergetic vectors into Equation (1) which represents the relationship between the first vector and the second vector, so as to represent the relationship between the first and second vectors with monoenergetic vectors according to Equation (6):

$$( 6 )$$

$$[ \begin{matrix}{D}_{1} & {D}_{2} & … & {D}_{n}\end{matrix} ] [ \text{} \begin{matrix}{ω}_{1}^{b} \\ {ω}_{2}^{b} \\ ⋯ \\ {ω}_{n}^{b}\end{matrix} ] = [ \begin{matrix}{C}_{1 , 1} & 0 & 0 & 0 \\ 0 & {C}_{2 , 2} & 0 & 0 \\ 0 & 0 & … & 0 \\ 0 & 0 & 0 & {C}_{m , m}\end{matrix} ] [ \begin{matrix}{D}_{1} & {D}_{2} & … & {D}_{n}\end{matrix} ] [ \begin{matrix}{ω}_{1}^{a} \\ {ω}_{2}^{a} \\ ⋯ \\ {ω}_{n}^{a}\end{matrix} ] ,$$

wherein D₁, D₂ . . . . Dₙ denote the monoenergetic vectors corresponding to the 1^{st} monoenergetic depth dose curve, the 2^{nd} monoenergetic depth dose curve . . . the n^{th} monoenergetic depth dose curve, respectively; ω₁^{a}, ω₂^{a} . . . ωₙ^{a} denote the first weights of the depth doses (e.g., percentage depth doses) corresponding to the 1^{st} monoenergetic depth dose curve, the 2^{nd} monoenergetic depth dose curve, . . . , the n^{th} monoenergetic depth dose curve, respectively, in the depth doses (e.g., percentage depth doses) corresponding to the first depth dose curve; ω₁^{b}, ω_{2b} . . ωₙ^{a} denote the second weights of the depth doses (e.g., percentage depth doses) corresponding to the 1^{st} monoenergetic depth dose curve, the 2^{nd} monoenergetic depth dose curve, . . . , the n^{th} monoenergetic depth dose curve, respectively, in the depth doses (e.g., percentage depth doses) corresponding to the second depth dose curve; diag (1.25, 1.11, . . . , 0.56) denotes the diagonal matrix C determined based on the first depth dose curve and the second depth dose curve.

Further, in some embodiments, the second energy spectrum determination module 250 may obtain the second weights based on Equation (6), and obtain the second energy spectrum of the second depth dose curve. In some embodiments, the second weights may be expressed by Equation (7):

$$[ \begin{matrix}{ω}_{1}^{b} \\ {ω}_{2}^{b} \\ ⋯ \\ {ω}_{n}^{b}\end{matrix} ] = {[ \begin{matrix}{D}_{1} & {D}_{2} & … & {D}_{n}\end{matrix} ]}^{- 1} [ \begin{matrix}{C}_{1 , 1} & 0 & 0 & 0 \\ 0 & {C}_{2 , 2} & 0 & 0 \\ 0 & 0 & … & 0 \\ 0 & 0 & 0 & {C}_{m , m}\end{matrix} ] [ \begin{matrix}{D}_{1} & {D}_{2} & … & {D}_{n}\end{matrix} ] [ \begin{matrix}{ω}_{1}^{a} \\ {ω}_{2}^{a} \\ ⋯ \\ {ω}_{n}^{a}\end{matrix} ] . \qquad ( 7 )$$

By way of example, continuing with the above example, the first energy spectrum of the first depth dose curve corresponding to the first energy 10 MeV comprises: 0.5% of a monoenergetic energy at 0.1 MeV, 1% of a monoenergetic energy at 0.2 MeV, . . . , and 0.2% of a monoenergetic energy at 10 MeV, then [ω₁^{a} ω₂^{a} . . . ωₙ^{a}]^{T}=[0.5% 1% . . . 0.2%] T; C=diag (C_{1,1}, C_{2,2}, . . . , C_{m,m})=diag (1.25,1.11, . . . , 0.56);

$$[ \begin{matrix}{D}_{1} & {D}_{2} & … & {D}_{100}\end{matrix} ] = [ \begin{matrix}40 & 50 & … & 90 \\ 42 & 54 & … & 92 \\ … & … & … & … \\ 45 & 55 & … & 96\end{matrix} ] .$$

Based on Eq. (7), the second weights [of ω₁^{b} . . . ωₙ^{b}]^{T} corresponding to the second energy 5 MeV may be obtained. For example, the second weights are determined to be: [0.1% 0.25% . . . . O] T, then the second energy spectrum of the second depth dose curve is determined to be: 0.1% of a monoenergetic energy at 0.1 MeV, 1% of a monoenergetic energy at 0.25 MeV, . . . , and 0% of a monoenergetic energy at 10 MeV

In the same manner, the energy spectrum acquisition system 200 may acquire second energy spectra of second depth dose curves corresponding to other second energies based on the first energy spectrum of the first depth dose curve. For example, the energy spectrum acquisition system 200 may acquire, based on the first energy spectrum of the first depth dose curve corresponding to 10 MeV, the second energy spectrum of the second depth dose curve corresponding to any second energy in a range of 0 to 10 MeV.

In some embodiments of the present disclosure, based on the relationship between the first depth dose curve and the second depth dose curve, and the first energy spectrum of the first depth dose curve, the second energy spectrum of the second depth dose curve can be rapidly acquired, improving the efficiency of the acquisition of the second energy spectrum.

In some embodiments, the second energy spectrum may be used to efficiently assess the impact of a radiation dose on a patient.

In some embodiments, the second energy spectrum may be used for dose calculations, thereby increasing the computational efficiency of predicting radiation dose distributions within the patient.

In some embodiments, the second energy spectrum may also be used for image correction. For example, the second energy spectrum is utilized to accurately calculate particle energies before and after scattering, thereby improving the accuracy of the image scatter correction.

FIG. 6 is a flowchart illustrating an exemplary process for obtaining a first energy spectrum of a first depth dose curve according to some embodiments of the present disclosure. Process 600 may be performed by the first energy spectrum acquisition module 240. As shown in FIG. 6, process 600 includes the following operations.

In 610, a plurality of monoenergetic depth dose curves may be determined based on a first energy.

A monoenergetic depth dose curve is a curve that describes how the depth dose changes with depth within a phantom irradiated by monoenergetic rays.

In some embodiments, when a first radiation beam irradiates the phantom, particles of different energies within the first radiation beam interact with atoms within the phantom, causing the atoms at various depths to absorb different amounts of energy from the particles of different energies. That is to say, particles of different energies in the first radiation beam contribute different amounts of energy to the depth dose (or absorbed dose) at various depths of the phantom. For example, after a first radiation beam I₁ irradiates the phantom, the absorbed dose at a depth d₁=1 cm of the phantom is D₁^{a}=8Gy, corresponding to a percentage depth dose of 87%. The contribution of particles with an energy of 0.1 MeV in the first radiation beam to the absorbed dose D₁^{a} at the depth d₁=1 cm is 0.05Gy, and the contribution of particles with an energy of 0.2 MeV to the absorbed dose D₁^{a} at the depth d₁=1 cm is 0.04Gy. Therefore, in some embodiments, at the same depth in the phantom, the percentage depth dose corresponding to the first radiation beam may be represented by the percentage depth doses corresponding to a plurality of monoenergetic rays, and the first depth dose curve of the first radiation beam may be represented by a plurality of monoenergetic depth dose curves corresponding to different monoenergetic energies.

A monoenergetic energy is an energy corresponding to a monoenergetic ray. For example, the monoenergetic energy of a monoenergetic ray composed of particles with an energy of 0.1 MeV is 0.1 MeV.

A monoenergetic energy interval is an interval between a plurality of monoenergetic energies corresponding to the plurality of monoenergetic depth dose curves used to represent the first depth dose curve.

In some embodiments, the first spectrum acquisition module 240 may determine the monoenergetic energy interval corresponding to the plurality of monoenergetic depth dose curves based on a spectrum accuracy and/or a spectrum calculation speed.

The spectrum accuracy refers to a degree of dispersion of multiple monoenergetic energies corresponding to multiple monoenergetic depth dose curves over an energy range of the first radiation beam.

In some embodiments, the spectrum accuracy may be determined based on user input.

In some embodiments, the energy spectrum accuracy may represent a ratio of the monoenergetic energy interval to the first energy corresponding to the first radiation beam. For example, if the spectrum accuracy is 0.01, it indicates that a ratio of the monoenergetic energy interval and the first energy corresponding to the first radiation beam is 0.01. It may be understood that the higher the spectrum accuracy is, the lower the dispersion of multiple monoenergetic energies over the energy range of the first radiation beam is, the more monoenergetic depth dose curves are used to represent the first depth dose curve, and the closer the obtained first depth dose curve is to the true value.

In some embodiments, the first spectrum acquisition module 240 may determine the monoenergetic energy interval based on a product of the spectrum accuracy and the first energy of the first radiation beam. For example, if the spectrum accuracy is 0.01 and the first energy is 10 MeV, the monoenergetic energy interval is 0.1 MeV.

The spectrum calculation speed refers to a parameter that evaluates the speed of calculating the first spectrum.

In some embodiments, the spectrum calculation speed may represent the time required to complete the calculation of the first spectrum. For example, the spectrum calculation speed may include 2s, indicating that it takes 2 seconds to complete the calculation of the first spectrum. More descriptions of the calculation of the first spectrum may be found in operation 620, which will not be repeated here.

In some embodiments, the spectrum calculation speed may be determined based on user input.

In some embodiments, the first energy spectrum acquisition module 240 may determine a count of initial monoenergetic energies based on the spectrum calculation speed, thereby determining the monoenergetic energy interval. Specifically, the first energy spectrum acquisition module 240 may pre-obtain a second relationship curve between the spectrum calculation speed and the count of initial monoenergetic energies, and determine, based on a spectrum calculation speed input by a user and the second relationship curve, the count of the initial monoenergetic energies. Further, the monoenergetic energy interval may be determined based on the first energy and the count of the initial monoenergetic energies. For example, if the spectrum calculation speed is 2s, and the count of the initial monoenergetic energies is 50, the monoenergetic energy interval may be determined as 0.2 MeV by dividing the first energy of 10 MeV by the count of the initial monoenergetic energies.

In some embodiments, the first energy spectrum acquisition module 240 may average the monoenergetic energy interval determined based on the spectrum accuracy and the monoenergetic energy interval determined based on the spectrum calculation speed to determine a final monoenergetic energy interval. For example, the first energy spectrum acquisition module 240 may average 0.1 MeV and 0.2 MeV, thereby determining a final monoenergetic energy interval of 0.15 MeV.

In some embodiments, the first energy spectrum acquisition module 240 may determine the acquisition method of the monoenergetic energy interval based on the parameters input by the user, thereby acquiring the monoenergetic energy interval. For example, if the user only inputs an energy spectrum accuracy of “0.01,” the first energy spectrum acquisition module 240 may determine that the final monoenergetic energy interval is the monoenergetic energy interval determined based on the spectrum accuracy, i.e., 0.1 MeV.

In some embodiments, the spectrum accuracy and the spectrum calculation speed may be default values set in advance.

In some embodiments, the first energy spectrum acquisition module 240 may obtain a monoenergetic energy interval input by the user from the at least one terminal device 130 and determine whether the monoenergetic energy interval input by the user satisfies the spectrum accuracy and/or the spectrum calculation speed. For example, if the monoenergetic energy interval input by the user does not satisfy the spectrum accuracy and/or the spectrum calculation speed, the first energy spectrum acquisition module 240 may prompt the user on the at least one terminal device 130 to re-input another monoenergetic energy interval or to display a recommended monoenergetic energy interval to the user based on the spectrum accuracy and/or the spectrum calculation speed.

It may be understood that the smaller the spectrum accuracy is and the slower the spectrum calculation speed is, the smaller the monoenergetic energy interval is, thus the larger the count of monoenergetic energies is. Correspondingly, more monoenergetic depth dose curves are used to represent the first depth dose curve and the second depth dose curve, leading to a lower overall computational efficiency of the system and a higher computational accuracy. More descriptions of representing the second depth dose curve with the monoenergetic depth dose curves may be found in the relevant description of operation 350, and will not be repeated herein.

In some embodiments, the first energy spectrum acquisition module 240 may determine a plurality of monoenergetic depth dose curves based on the first energy and the monoenergetic energy interval.

Specifically, in some embodiments, the first energy spectrum acquisition module 240 may designate an energy that is at a monoenergetic energy interval from 0 MeV as a first monoenergetic energy, and then sequentially determine a plurality of energies based on the monoenergetic energy interval until the first energy is exceeded, thereby obtaining a plurality of energies that do not exceed the first energy as the monoenergetic energies. For example, 0.1 MeV is used as the first monoenergetic energy, and then based on the monoenergetic energy interval of 0.1 MeV, a plurality of energies are sequentially determined: 0.1 MeV, 0.2 MeV, . . . , 10 MeV, 10.1 MeV, wherein 10.1 MeV is greater than the first energy of 10 MeV, then a plurality of energies not exceeding 10 MeV: 0.1 MeV, 0.2 MeV, . . . , 10 MeV may be determined as the plurality of monoenergetic energies.

Further, in some embodiments, the first energy spectrum acquisition module 240 may determine a plurality of monoenergetic depth dose curves corresponding to the plurality of monoenergetic energies based on the plurality of monoenergetic energies. In some embodiments, the first energy spectrum acquisition module 240 may simulate the monoenergetic depth dose curves corresponding to the plurality of monoenergetic energies under the same measurement condition used for obtaining the first depth dose curve, using a Monte Carlo algorithm. More descriptions of the same measurement condition may be found in the description associated with operation 310 and will not be repeated herein.

For example, the first energy spectrum acquisition module 240 may acquire n=100 monoenergetic depth dose curves: E₁, E₂, . . . . E₁₀₀ corresponding to n=100 monoenergetic energies: 0.1 MeV, 0.2 MeV, . . . , 10 MeV based on the 100 monoenergetic energies.

Some embodiments of the present disclosure determine the monoenergetic energy interval based on the spectrum accuracy and/or the spectrum calculation speed and determine the monoenergetic depth dose curves based on the monoenergetic energy interval. This approach not only ensures the accuracy of the monoenergetic depth dose curves representing the first depth dose curve but also limits the count of the columns of the first and second vectors that are represented by the monoenergetic energies, thus enhancing the computation efficiency of the entire system. More descriptions of representing the first and second vectors with monoenergetic energies may be found in the related description of operation 350, which will not be repeated here.

In 620, the first energy spectrum corresponding to the first depth dose curve may be obtained based on the first depth dose curve and the plurality of monoenergetic depth dose curves.

The first energy spectrum is a description of monoenergetic energies contained in the first radiation beam and the first weights corresponding to the monoenergetic energies.

In some embodiments, a relationship between a first weight corresponding to a monoenergetic energy, a monoenergetic depth dose curve corresponding to the monoenergetic energy, and a first depth dose curve corresponding to the first radiation beam may be expressed by Equation (8):

$${PDD}^{a} = {\sum }_{i = 1}^{n} {ω}_{i}^{a} {PDD}_{i} , \qquad ( 8 )$$

wherein PDD^{a} denotes the first depth dose curve, n denotes an n^{th} monoenergetic depth dose curve, PDDᵢ denotes an i^{th} monoenergetic depth dose curve, and ωᵢ^{a} denotes the first weigh of the depth dose (e.g., percentage depth dose) corresponding to the i^{th} monoenergetic depth dose curve in the depth dose (e.g., percentage depth dose) corresponding to the first depth dose curve.

From Eq. (8), based on the first weights corresponding to the monoenergetic energies, depth doses (e.g., percentage depth doses) corresponding to the same depth on multiple monoenergetic depth dose curves is weighted and summed, and the depth dose (e.g., percentage depth dose) corresponding to the depth on the second depth dose curve may be obtained. The first weight corresponding to each monoenergetic energy may indicate the contribution of the corresponding monoenergetic ray to the depth dose (e.g., percentage depth dose) of the phantom in the first radiation beam.

In some embodiments, the first energy spectrum may be a Monte Carlo energy spectrum. Correspondingly, in some embodiments, the first energy spectrum acquisition module 240 may obtain the first energy spectrum of the first depth dose curve through techniques such as an ant colony optimization (ACO) algorithm, a simulated anneal arithmetic (SAA) algorithm, a Monte Carlo (MC) algorithm, or the like.

By way of example, the Monte Carlo algorithm is used as an example. The Monte Carlo algorithm is a stochastic simulation method that allows obtaining the dose distribution of particles in a phantom by stochastically simulating the process of interaction of particles in a radiation beam with atoms in the phantom.

In some embodiments, the first energy spectrum acquisition module 240 may simulate a plurality of monoenergetic depth dose curves based on the Monte Carlo algorithm to obtain a phase space file. The phase space file refers to simulated information of the coupled transport of particles of different energies in the radiation beam. In some embodiments, the phase space file may include, but is not limited to, information such as particle energies at specific planes, types of particles, positional coordinates of the particles, directions of incidence of the particles, statistical weights of the particles, or the like.

Further, in some embodiments, the first energy spectrum acquisition module 240 may analyze the first depth dose curve based on the phase space file of the device 110 to obtain the first energy spectrum of the first depth dose curve. For example, the first energy spectrum of the first depth dose curve may include the first weights corresponding to 100 monoenergetic energies: 0.5% of a monoenergetic energy at 0.1 MeV, 1% of a monoenergetic energy at 0.2 MeV, . . . , and 0.2% of a monoenergetic energy at 10 MeV.

Some embodiments of the present disclosure determine the first energy spectrum of the first depth dose curve based on the Monte Carlo algorithm, which can improve the accuracy of the first energy spectrum, thereby enhancing the accuracy of the second energy spectrum determined based on the first energy spectrum.

In some embodiments, the first energy spectrum may be an y-spectrum. Correspondingly, in some embodiments, the first energy spectrum acquisition module 240 may obtain the first energy spectrum by simulating a plurality of monoenergetic depth dose curves based on a convolutional algorithm.

In some embodiments, the first energy spectrum may also be an electron energy spectrum. Correspondingly, in some embodiments, the first energy spectrum acquisition module 240 may obtain the first energy spectrum by simulating a plurality of monoenergetic depth dose curves based on based on an AXB algorithm.

Beneficial effects of the embodiments of the present disclosure include, but are not limited to: (1) by discretizing the first depth dose curve and the second depth dose curve using the first set of dose values and the second set of dose values to respectively represent the first and second depth dose curves, and representing a ratio of a dose value in the first set of dose values to a dose value in the second set of dose values using a corresponding value in the relational data represents, the relationship between the first and second depth dose curves is expressed through a simple operational relationship (e.g., a vector operation relationship), thereby improving the computational efficiency; (2) based on the quickly acquired relationship between the first and second depth dose curves, the spectrum of any other energy band can be obtained quickly based on the obtained first spectrum (e.g., a Monte Carlo spectrum with high accuracy) without relying on spectrum optimization algorithms, which improves the adaptability for obtaining spectra for other energy bands and saves time in acquiring spectra. It should be noted that the beneficial effects produced by different embodiments may vary. In different embodiments, the potential beneficial effects may be any combination of the aforementioned beneficial effects or any other potential beneficial effects.

Having thus described the basic concepts, it may be rather apparent to those skilled in the art after reading this detailed disclosure that the foregoing detailed disclosure is intended to be presented as illustrative example and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of the present disclosure.

Moreover, certain terminology has been configured to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be noted that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for obtaining an energy spectrum, comprising:
obtaining a first depth dose curve corresponding to a first energy and a second depth dose curve corresponding to a second energy;
obtaining, based on the first depth dose curve and the second depth dose curve, a first set of dose values and a second set of dose values along a depth direction, respectively;
determining a relationship between the first depth dose curve and the second depth dose curve based on the first set of dose values and the second set of dose values;
obtaining a first energy spectrum corresponding to the first depth dose curve; and
determining a second energy spectrum corresponding to the second depth dose curve based on the first energy spectrum and the relationship between the first depth dose curve and the second depth dose curve.

2. The method of claim 1, wherein the relationship between the first depth dose curve and the second depth dose curve is determined based on a ratio of at least one dose value in the first set of dose values to at least one dose value in the second set of dose values that corresponds to the at least one dose value in the first set of dose values.

3. The method of claim 1, wherein a maximum measurement depth corresponding to the first depth dose curve and a maximum measurement depth corresponding to the second depth dose curve are determined based on a thickness and/or a material of a phantom.

4. The method of claim 1, wherein the obtaining, based on the first depth dose curve and the second depth dose curve, a first set of dose values and a second set of dose values along a depth direction, respectively includes:
obtaining the first set of dose values by inputting the first depth dose curve into a discretization model; and
obtaining the second set of dose values by inputting the second depth dose curve into the discretization model.

5. The method of claim 3, wherein the obtaining, based on the first depth dose curve and the second depth dose curve, a first set of dose values and a second set of dose values along a depth direction, respectively includes:
determining intervals of discrete points;
determining the discrete points based on the maximum measurement depth and the intervals of discrete points; and
obtaining the first set of dose values and the second set of dose values corresponding to the discrete points by discretizing the first depth dose curve and the second depth dose curve based on the discrete points.

6. The method of claim 5, wherein the determining intervals of discrete points includes:
determining the intervals of discrete points based on a discretization precision and/or a discretization speed.

7. The method of claim 1, wherein the first energy is not less than the second energy.

8. The method of claim 1, wherein the obtaining a first energy spectrum corresponding to the first depth dose curve includes:
determining a plurality of monoenergetic depth dose curves based on the first energy; and
obtaining the first energy spectrum corresponding to the first depth dose curve based on the first depth dose curve and the plurality of monoenergetic depth dose curves.

9. The method of claim 8, wherein the determining a plurality of monoenergetic depth dose curves based on the first energy includes:
determining monoenergetic energy intervals corresponding to the plurality of monoenergetic depth dose curves; and
determining the plurality of monoenergetic depth dose curves based on the first energy and the monoenergetic energy intervals.

10. The method of claim 8, wherein the obtaining the first energy spectrum corresponding to the first depth dose curve based on the first depth dose curve and the plurality of monoenergetic depth dose curves includes:
obtaining a phase space file by simulating the plurality of monoenergetic depth dose curves using a Monte Carlo algorithm; and
obtaining the first energy spectrum corresponding to the first depth dose curve based on the phase space file and the first depth dose curve.

11. The method of claim 2, wherein
the first set of dose values and the second set of dose values are represented by a first vector and a second vector, respectively, and
the relationship between the first depth dose curve and the second depth dose curve is represented by a diagonal matrix, wherein
a non-zero element of each row in the diagonal matrix is determined based on a ratio of an element in a corresponding row in the second vector to an element in a corresponding row in the first vector.

12. The method of claim 11, wherein the determining a second energy spectrum corresponding to the second depth dose curve based on the first energy spectrum and the relationship between the first depth dose curve and the second depth dose curve includes:
representing the first vector with monoenergetic vectors corresponding to monoenergetic depth dose curves and first weights of depth doses corresponding to the monoenergetic depth dose curves in depth doses corresponding to the first depth dose curve;
representing the second vector with the monoenergetic vectors corresponding to the monoenergetic depth dose curves and second weights of the depth doses corresponding to the monoenergetic depth dose curves in depth doses corresponding to the second depth dose curve;
representing, based on the first vector and the second vector, the relationship between the first depth dose curve and the second depth dose curve by the first weights, the second weights, the monoenergetic vectors, and the diagonal matrix;
determining, based on the first energy spectrum and the representation of the relationship between the first depth dose curve and the second depth dose curve, the second energy spectrum corresponding to the second depth dose curve.

13. The method of claim 12, wherein the determining, based on the first energy spectrum and the representation of the relationship between the first depth dose curve and the second depth dose curve, the second energy spectrum corresponding to the second depth dose curve includes:
determining, based on the first energy spectrum and the monoenergetic vectors, the first weights;
determining the second weights based on the first weights, the monoenergetic vectors, the diagonal matrix, and the representation of the relationship between the first depth dose curve and the second depth dose curve;
determining the second energy spectrum corresponding to the second depth dose curve based on the second weights and the monoenergetic vectors.

14. A system for obtaining an energy spectrum, comprising:
a curve acquisition module, configured to obtain a first depth dose curve corresponding to a first energy and a second depth dose curve corresponding to a second energy;
a dose value acquisition module, configured to obtain, based on the first depth dose curve and the second depth dose curve, a first set of dose values and a second set of dose values along a depth direction, respectively;
a relationship determination module, configured to determine a relationship between the first depth dose curve and the second depth dose curve based on the first set of dose values and the second set of dose values;
a first energy spectrum acquisition module, configured to obtain a first energy spectrum corresponding to the first depth dose curve; and
a second energy spectrum determination module, configured to determine a second energy spectrum corresponding to the second depth dose curve based on the first energy spectrum and the relationship between the first depth dose curve and the second depth dose curve.

15. The system of claim 14, wherein the relationship between the first depth dose curve and the second depth dose curve is determined based on a ratio of at least one dose value in the first set of dose values to at least one dose value in the second set of dose values that corresponds to the at least one dose value in the first set of dose values.

16. The system of claim 10, wherein the dose value acquisition module is further configured to:
determine intervals of discrete points;
determine the discrete points based on the maximum measurement depth and the intervals of discrete points; and
obtain the first set of dose values and the second set of dose values corresponding to the discrete points by discretizing the first depth dose curve and the second depth dose curve based on the discrete points.

17. The system of claim 14, wherein the first energy spectrum acquisition module is further configured to:
determine a plurality of monoenergetic depth dose curves based on the first energy; and
obtain the first energy spectrum corresponding to the first depth dose curve based on the first depth dose curve and the plurality of monoenergetic depth dose curves.

18. The system of claim 17, the first energy spectrum acquisition module is further configured to:
determine monoenergetic energy intervals corresponding to the plurality of monoenergetic depth dose curves; and
determine the plurality of monoenergetic depth dose curves based on the first energy and the monoenergetic energy intervals.

19. The system of claim 17, wherein the first energy spectrum acquisition module is further configured to:
obtain a phase space file by simulating the plurality of monoenergetic depth dose curves using a Monte Carlo algorithm; and
obtain the first energy spectrum corresponding to the first depth dose curve based on the phase space file and the first depth dose curve.

20. A device for obtaining an energy spectrum, comprising at least one processor and at least one storage device, wherein the at least one storage device is configured to store computer instructions, the at least one processor is configured to execute at least a portion of the computer instructions to implement the method for obtaining an energy spectrum comprising:
obtaining a first depth dose curve corresponding to a first energy and a second depth dose curve corresponding to a second energy;
obtaining, based on the first depth dose curve and the second depth dose curve, a first set of dose values and a second set of dose values along a depth direction, respectively;
determining a relationship between the first depth dose curve and the second depth dose curve based on the first set of dose values and the second set of dose values;
obtaining a first energy spectrum corresponding to the first depth dose curve; and
determining a second energy spectrum corresponding to the second depth dose curve based on the first energy spectrum and the relationship between the first depth dose curve and the second depth dose curve.
